(19) United States
(12) Patent Application Publication
(10) Pub. No.: US 2010/0215294 A1
(43) Pub. Date: Aug. 26, 2010

(54) DISPOSABLE BEVERAGE POUCH WITH NIPPLE

(75) Inventor: Ronald H. Berman, Long Beach, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: BOSCH POUCH SYSTEMS AG, Neuhausen (CH)

(21) Appl. No.: 12/392,813

(22) Filed: Feb. 25, 2009

(51) Int. Cl. B65D 33/00; B65D 33/16; A61J 9/00; A61J 11/00

(52) U.S. Cl. 383/202; 383/80; 215/11.1; 606/236

(57) ABSTRACT

A disposable beverage container is disclosed having an aseptic flexible pouch filled with a beverage, and a nipple apparatus attached to an upper surface. The pouch preferably has a patch and the nipple apparatus sits on the patch. The nipple includes one or more cutting teeth that, when actuated by a user, pierces the flexible pouch to cause beverage to flow into the nipple where it can be consumed by a child.

### BACKGROUND

The present invention is related to disposable beverage pouches, and more particularly to a disposable flexible pouch with a nipple affixed thereto.

Flexible beverage pouches are well known in the art. The pouches are typically filled with juice, punch, or flavored water and are particularly well-suited for children. These pouches are formed of a multi-layer film and with a special straw hole punch material that can be pierced with a straw to allow the beverage to be consumed. However, very small children and infants lack the ability to use a straw, and thus the pouches cannot be used with very small children and infants.

The beverage pouches which are currently being marketed are fabricated from a multi-layered laminated sheet of material which consists of polyester film/printing ink/coating adhesive/metal foil or EVOH/coating adhesive/heat-sealable plastic (e.g., polyethylene) film. Such a laminate is further described in U.S. Pat. Nos. 6,116,782 and 5,425,583, which are hereby incorporated by reference.

### SUMMARY OF THE INVENTION

The present invention utilizes flexible beverage pouch technology and its inherent capacity to store beverages for extended periods of time in an aseptic or clean condition. A nipple is attached to an independent flange of application on a machine (the nipple unit). A generally flexible nipple body includes a small aperture at a distal end, the nipple body mounted on a cylindrical housing (the unit) in a fluid tight relationship. The cylindrical housing is affixed to an annular platform that is bonded to a surface of the patch material and the patch material is attached to the pouch. The platform has a threaded flange that cooperates with threads on the cylindrical housing to couple the platform to the cylindrical housing. The platform preferably includes a continuous bonding ridge on a bottom surface that promotes ultrasonic bonding of the platform to the pouch surface. The cylindrical housing further comprises vertically reciprocating cutting teeth disposed adjacent a surface of the pouch inside the continuous bonding ridge. The reciprocating cutting teeth are driven against the patch surface to rupture the patch surface and open the pouch upon rotation of the cylindrical housing about the threaded spout, where fluid contained in the pouch can thereafter enter the nipple body and be dispensed through the nipple's small aperture.

The contents of the pouch is aspetically preserved, and thus in a sterile condition until the pouch is punctured by the cutting teeth. This provides a portable, aseptic dispenser for formula, milk, juice, and other infant beverages that is portable, compact, self-contained, and can be stored for long periods of time until needed. The film can also be selected such that the pouch can be heated to ready the contents for serving.

### BRIEF DESCRIPTION OF THE DRAWINGS

FIG. 1 is an elevated perspective view of a first preferred embodiment of the present invention;

FIG. 2 is a side view of the embodiment of FIG. 1;

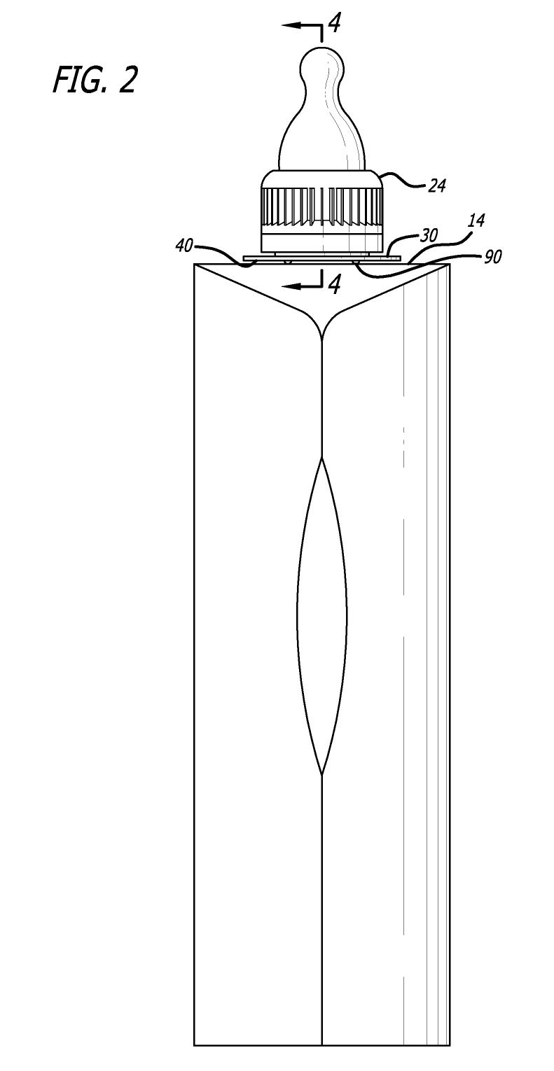

FIG. 3 is an elevated exploded view of the nipple/spout/cutting teeth; and

FIG. 4 is a cross-sectional view of the nipple/spout/cutting teeth.

### DETAILED DESCRIPTION OF THE PREFERRED EMBODIMENTS

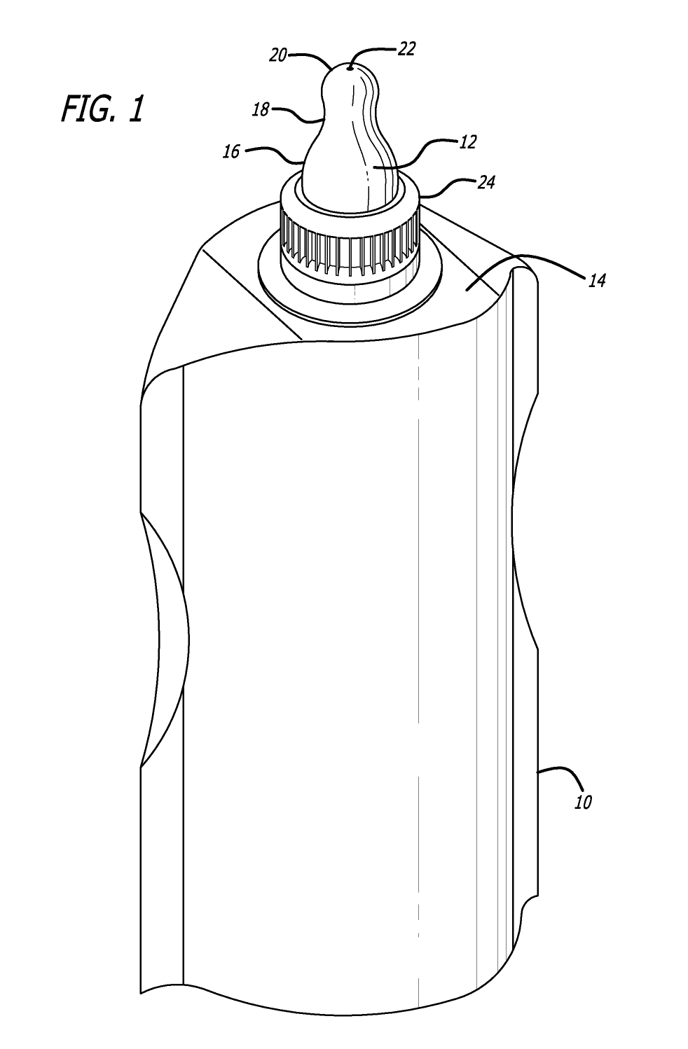

FIG. 1 illustrates a first preferred embodiment of the present invention including a flexible beverage pouch 10 in combination with a nipple 12 disposed on a top surface 14. The thin walled beverage pouch can take a number of different shapes and sizes, and the pouch illustrated in FIG. 1 is merely an example of the type of pouch that the present invention can be used with. Pouches of this type are typically made of a multiple plies of foil, plastic, and the like to create a environment that can be made sterile and aseptic. Traditionally these types of pouches have been fitted with a straw hole or spout that enabled a user to drink the contents. However, infants and small children cannot operate a straw or pouch and can therefore spill the contents on their clothing. This can be particularly problematic if the contents is something that will stain clothing. The present invention addresses this problem.

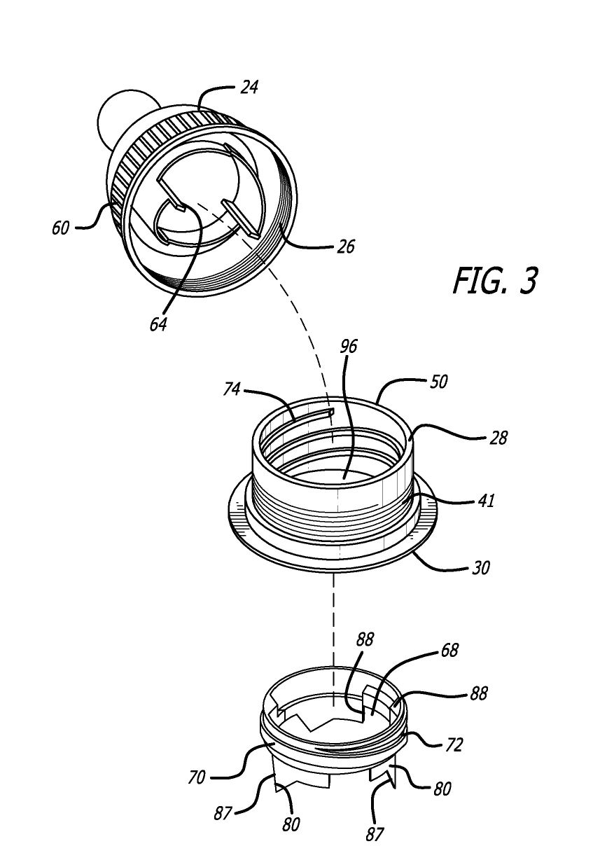

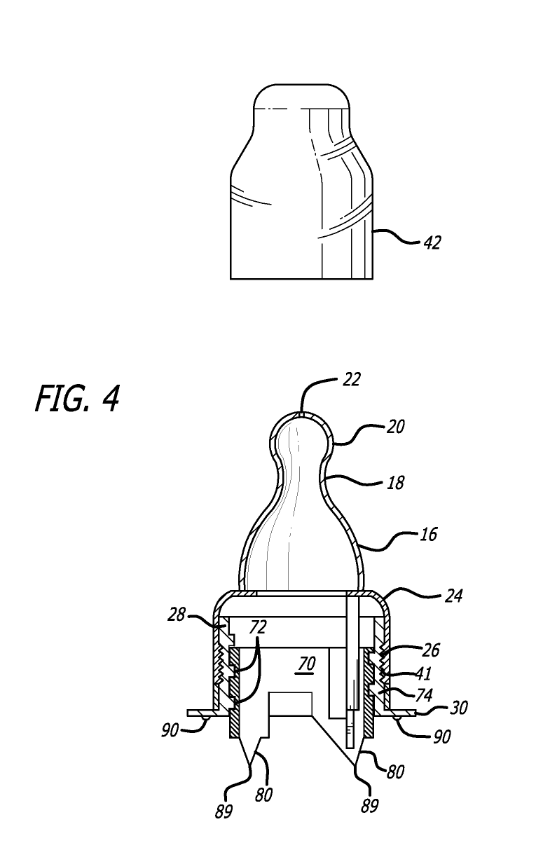

The nipple 12 is flexible and includes a body portion 16 that terminates at a neck portion 18 that leads to a bulbous distal end 20. A small opening 22 is disposed in the bulbous distal end 20 to permit fluid to exit the nipple 12. A cylindrical base 24 connects the nipple 12 in a fluid tight relationship, such as by press fit, heat, or other mechanical seal as is known in the art. The cylindrical base 24 has a threaded inner surface 26 that rides on an annular projection 28 of a spout 50, where the annular projection 28 sits vertically disposed on a platform 30. The threads 26 engage mating threads 41 on the exterior of the annular projection 28 to form a fluid tight relationship between the spout 50 and the cylindrical base 24. Once tightened on the spout 50, the nipple 12 provides a flow path from the interior of the pouch 10 to the opening 22 at the tip of the nipple to allow the infant to drink from the pouch. However, the pouch must first be punctured or otherwise opened below the nipple to gain access to the contents of the pouch 10. FIGS. 3 and 4 illustrate a preferred embodiment for opening the pouch to gain access to the contents therein.

The cylindrical base 24 is provided with a rotationally mounted annular portion 60 that is coupled to a set of radially inwardly projecting teeth 64 that depend downwardly and axially within the cylindrical base 24. The teeth 64 are positioned to rotate with annular portion 60, which can freely rotate about a longitudinal axis of the cylindrical base 24 independent of the engagement of the threads 26,41. The teeth 64 are seated in keyed portions 68 of a piercing member 70 that reciprocate axially within the spout 50. Piercing member 70 has external threads 72 that engage with internal threads 74 of the spout 50 to move the piercing member 70 axially within the spout 50, and extending out of the spout. The piercing member is configured with sharp cutting projections 80 pointed in the direction of the upper surface 14 of the pouch 10. When the nipple 12 is located on the spout 50 and the user wants to consume the contents of the pouch 10, the user rotates the annular portion 60 of the nipple's cylindrical base 24 which causes the teeth 64 to rotate in the same direction as the annular portion 60. Rotation of the teeth 64 engage the side walls 88 of the keyed portions 68 of the piercing member 70, driving the piercing member in the same direction as the rotation of the annular member 60. Rotation of the piercing member causes the threads 72 to engage the threads 74 on the spout and force the piercing member 70 downward toward the pouch upper surface 14. Further rotation causes the cutting projections 80 to puncture the upper surface 14 of the pouch 10, tearing the upper surface to allow a fluid therein to flow into the nipple 12 and be consumed.

The cutting projections 80 may include a serrated edge 87 that terminates in an apex 89. In the retracted position, the cutting projections 80 are completely disposed within the cylindrical base 24. As the cylindrical base 24 is rotated, the cutting projections 80 are driven downward through a window 96 in the spout 50 against the top surface 14 of the thin walled beverage pouch 10. Further rotation of the cylindrical base 24 drives the cutting projections 80 to pierce the top surface 14 of the beverage pouch 10, breaking the seal and creating a passage for the beverage to enter the nipple 12. When the beverage pouch is inverted, gravity will cause the fluid to pass through the newly created opening in the top surface 14 caused by the cutting projections 80 and enter the nipple, where it can be sucked out through the small opening 22 at the distal end.

In an alternative embodiment, the cylindrical base can be the component that drives the piercing member 70 by further rotation on the spout 50. That is, the nipple is rotated onto the spout 50 to provide a secure engagement to ensure that the nipple 12 will not become dislodged or accidentally removed from the pouch 10. When the user is ready to open the pouch, the cylindrical base 24 is rotated clockwise to drive the piercing member 70 downward by virtue of the movement of the driving teeth 64 as described above. In this embodiment there is no need for a portion of the nipple 12 to rotate independently of the rest of the nipple, simplifying the mechanism.

In a preferred embodiment, the spout 50 can be attached to the pouch 10 at a downwardly projecting annular ridge 90 shown in FIG. 4. The ridge 90 attaches to the upper surface 14 of the pouch 10 as by ultrasonic bonding, welding, adhesive, or the like. The spout material is chosen to bond with the outer surface of the pouch, or alternative the spout can bond to a patch within the pouch as described in U.S. patent application Ser. No. 11/471,930, the contents of which are fully incorporated herein by reference. The bond between the surface of the pouch 10 and the platform 30 must be sufficient to hold as the cutting projections 80 are pressing against the surface of the pouch to provide a taught surface that may be pierced by the teeth.

The nipple 12 can be fitted with a removable cap 42 that preserves the aseptic condition of the nipple prior to use. The user first removes the cap 42, which can be snap fit into a groove or over a ridge on the upper surface of the cylindrical base 24, and can be sealed using a plastic shrink wrap or other means for preserving the condition of the nipple.

I claim:

1. A disposable beverage container for an infant comprising:
a flexible pouch configured to store a beverage therein, said flexible pouch including an upper surface; and
a nipple including a resilient dispensing end with an aperture at a distal end for permitting the beverage to pass through the nipple, a cylindrical base supporting said resilient dispensing end, the cylindrical base housing at least one downwardly projecting reciprocating cutting tooth, and a platform mounting said cylindrical base for rotational movement about a longitudinal axis;
wherein rotational movement of said cylindrical base about said platform drives said cutting tooth to pierce the flexible pouch at the upper surface to introduce the beverage into said nipple for flow through said aperture.

2. The disposable beverage container of claim 1 wherein said beverage container includes an interior in an aseptic condition prior to piercing by said cutting tooth.

3. The disposable beverage container of claim 1 wherein said cutting tooth has a serrated first edge.

4. The disposable beverage container of claim 1 wherein said platform has a downwardly directed annular projection for ultrasonically bonding said platform to flexible pouch.

5. The disposable beverage container of claim 1 further comprising a removable cover sized to fit over said flexible nipple body and attach to said cylindrical base.

6. A nipple for use with a flexible beverage container comprising:
a flexible nipple body having a body portion, a neck portion, and a bulbous distal end including an aperture in said distal end;
a cylindrical base attached to said flexible nipple body in a fluid tight relationship;
a platform having a bottom surface for bonding to said thin-walled beverage container and a top surface for attaching said cylindrical base, said platform having a window in a central area; and
at least one reciprocating cutting tooth adapted to project through said window of said platform and pierce said thin-walled beverage container upon rotation of said cylindrical base.

7. The nipple of claim 6 wherein the platform has a downwardly directed annular projection for ultrasonically bonding said platform to said beverage container.

8. The nipple of claim 6 further comprising a removable cover sized to fit over said flexible nipple body and attach to said cylindrical base.
